(19) United States
(12) Patent Application Publication
(10) Pub. No.: US 2020/0353583 A1
(43) Pub. Date: Nov. 12, 2020

(54) WORKPIECE IDENTIFICATION METHOD

(71) Applicant: TOYOTA JIDOSHA KABUSHIKI KAISHA, Toyota-shi (JP)

(72) Inventors: Akira TSUKUI, Nagoya-shi (JP); Masaki KOIKE, Nagoya-shi (JP)

(21) Appl. No.: 16/847,963

(22) Filed: Apr. 14, 2020

(30) Foreign Application Priority Data
May 9, 2019 (JP) 2019-088965

(51) Int. Cl. B23Q 17/24

(52) U.S. Cl. CPC B23Q 17/2447; B23Q 17/249; B23Q 17/2471

(57) ABSTRACT

A method for identifying a workpiece includes: taking an image of a workpiece storage area; determining whether there is the workpiece in the workpiece storage area based on the image taken; determining, whether there is an overlap where soft parts of the workpieces overlap one another in the workpiece storage area, based on the image; identifying an uppermost soft part that is located at a highest position among the overlapping soft parts, based on the image; and determining the workpiece having the identified uppermost soft part as an uppermost workpiece that is located at a highest position among the workpieces in the workpiece storage area.

### INCORPORATION BY REFERENCE

The disclosure of Japanese Patent Application No. 2019-088965 filed on May 9, 2019 including the specification, drawings and abstract is incorporated herein by reference in its entirety.

### BACKGROUND

### 1. Technical Field

The disclosure relates to a method for identifying a workpiece.

### 2. Description of Related Art

Japanese Unexamined Patent Application Publication No. 2010-69542 (JP 2010-69542 A) describes the following workpiece picking method. Specifically, a three-dimensional measurement is performed on workpieces stacked randomly using a distance sensor, and the acquired measurement results are compared with a three-dimensional computer-aided design (CAD) model of the workpieces to recognize a three-dimensional position and posture of each workpiece. After that, a robot hand picks the workpiece whose three-dimensional position and posture has been recognized.

### SUMMARY

There are cases where a workpiece constituted by a rigid part and a soft part having a flexible linear shape is a target of picking. Examples of the workpiece include a wire harness constituted by a connector that is a rigid part and a cable that is a soft part having a flexible linear shape. When such workpieces are stacked randomly, individual workpieces may not be able to be properly picked up by the workpiece picking method of JP 2010-69542 A.

Specifically, for the workpiece constituted by the rigid part and the soft part having a flexible linear shape, there is three-dimensional CAD data of the rigid part, but there is no three-dimensional CAD data of the soft part having a flexible linear shape (in other words, an indefinite shape). Accordingly, when matching the three-dimensional measurement data of the workpiece with the three-dimensional CAD data as in JP 2010-69542 A, the three-dimensional measurement data is matched with the three-dimensional CAD data for the rigid part having the three-dimensional CAD data so as to recognize the three-dimensional position and posture of the rigid part. Thus, the three-dimensional position and posture of the soft part having no three-dimensional CAD data cannot be recognized. Therefore, after the three-dimensional position and posture of the rigid part are recognized by matching the three-dimensional measurement data with the three-dimensional CAD data of the rigid part, the workpiece having the rigid part is picked while the rigid part is held.

However, when there is a plurality of workpieces (stacked randomly) with their soft parts overlapping one another, a soft part of a first workpiece may overlap a soft part of a second workpiece having a rigid part whose three-dimensional position and posture has been recognized. In such a case, when the robot hand picks up the second workpiece by holding the rigid part whose three-dimensional position and posture has been recognized, the first workpiece whose soft part is overlapping the soft part of the second workpiece may be picked up together with the second workpiece. This means that the plurality of workpieces is simultaneously picked up by the robot hand, and the weight of the workpieces to be held by the robot hand may exceed an assumed weight (allowable weight). As a result, the robot hand may not be able to maintain its workpiece holding state and thus may drop the workpiece held and the workpiece picked up together therewith. Thus, an identification method has been desired for identifying a workpiece located at the highest position, when there is a plurality of workpieces (stacked randomly) in a workpiece storage area with their soft parts overlapping one another.

The disclosure provides a method for identifying a workpiece, which can identify an uppermost workpiece located at the highest position when there is a plurality of workpieces (stacked randomly) in a workpiece storage area with their soft parts overlapping one another.

A first aspect of the disclosure relates to a method for identifying a workpiece. The method includes: taking an image of a workpiece storage area in which a plurality of workpieces is placed, each of the workpieces including a rigid part and a soft part having a flexible linear shape; determining whether there is the workpiece in the workpiece storage area based on the image taken; determining, when it is determined that there is the workpiece, whether there is an overlap where the soft parts of the workpieces overlap one another in the workpiece storage area, based on the image; identifying, when it is determined that there is the overlap, an uppermost soft part that is located at a highest position among the overlapping soft parts, based on the image; and determining the workpiece having the identified uppermost soft part as an uppermost workpiece that is located at a highest position among the workpieces in the workpiece storage area.

In the method of the above aspect, the workpiece constituted by the rigid part and the soft part having the flexible linear shape is a workpiece to be identified. With this method, it is possible to identify, when there are workpieces (stacked randomly) in the workpiece storage area with their soft parts overlapping one another, the uppermost workpiece located at the highest position among the workpieces.

The method of the above aspect includes, for example, an image-taking step, a workpiece presence/absence determination step, an overlap presence/absence determination step, an uppermost soft part identification step, and an uppermost workpiece determination step. In the image-taking step, an image of the workpiece storage area where the workpieces are placed is taken. Each of the workpieces includes the rigid part and the soft part having the flexible linear shape (in other words, an indefinite linear shape). In the workpiece presence/absence determination step, it is determined whether there is the workpiece in the workpiece storage area based on the image acquired in the image-taking step. In the overlap presence/absence determination step, when it is determined that there is the workpiece in the workpiece storage area in the workpiece presence/absence determination step, it is determined whether there is the overlap where the soft parts of the workpieces overlap. In the uppermost soft part identification step, when it is determined that there is the overlap in the overlap presence/absence determination step, the uppermost soft part located at the highest position among the overlapping soft parts is identified based on the image. In the uppermost workpiece determination step, the workpiece having the uppermost soft part identified in the uppermost soft part identification step is determined as the uppermost workpiece that is located at the highest position among the workpieces in the workpiece storage area.

In the method of the above aspect, after the uppermost soft part is identified and before the uppermost workpiece is determined, whether the soft part and the rigid part are recognizable may be determined for the workpiece having the identified uppermost soft part based on the image, and when it is determined that the soft part and the rigid part are recognizable, the workpiece having the uppermost soft part may be determined as the uppermost workpiece.

In the method of the above aspect, it is determined whether the soft part and the rigid part can be recognized for the workpiece having the identified uppermost soft part. Here, a case where the soft part and the rigid part can be recognized for the workpiece having the uppermost soft part is a case, for example, where the entire soft part and the entire rigid part appear in the acquired image and the entire soft part and the entire rigid part can be observed in the acquired image. Thus, by recognizing the soft part and the rigid part of the workpiece having the identified uppermost soft part, it is possible to confirm the workpiece as the workpiece constituted by the rigid part and the soft part (with the rigid part and the soft part integrated). Accordingly, it is possible to identify the uppermost workpiece more appropriately.

The method of the above aspect may further include a workpiece recognition possibility determination step after the uppermost soft part identification step and before the uppermost workpiece determination step. In the workpiece recognition possibility determination step, it is determined whether the soft part and the rigid part can be recognized for the workpiece having the uppermost soft part identified in the uppermost soft part identification step based on the image. When it is determined in the workpiece recognition possibility determination step that the soft part and the rigid part can be recognized, the workpiece having the uppermost soft part is determined as the uppermost workpiece in the uppermost workpiece determination step.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a diagram showing a configuration of a pickup device according to an embodiment;

FIG. 2 is a plan view of a workpiece;

FIG. 3 is a flowchart illustrating a flow of a method for identifying a workpiece according to the embodiment;

FIG. 4 is an example of an image acquired by imaging;

FIG. 5 is a partially enlarged view of the image of FIG. 4; and

FIG. 6 is a diagram illustrating the method for identifying a workpiece according to the embodiment.

### DETAILED DESCRIPTION OF EMBODIMENTS

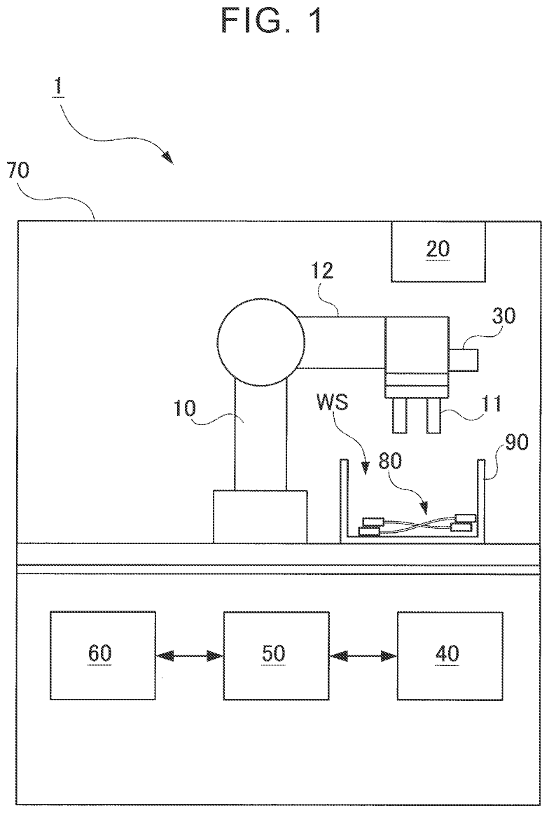

An embodiment of the disclosure will be described with reference to the drawings. FIG. 1 is a diagram showing a configuration of a pickup device 1 according to the embodiment. As shown in FIG. 1, the pickup device 1 includes a pickup robot 10, a three-dimensional (3D) vision sensor 20, a two-dimensional (2D) vision sensor 30, an image analysis unit 40, a robot controller 50, a 3D vision controller 60, and a frame 70.

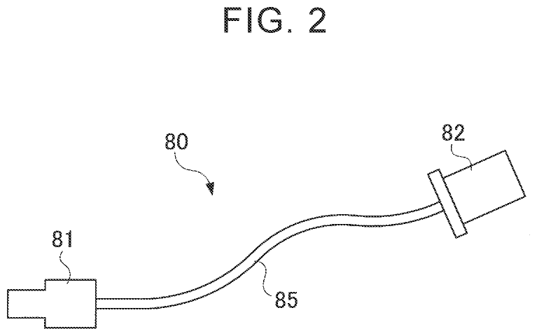

The pickup device 1 is a device that holds and takes out workpieces 80 one by one from a workpiece storage box 90, among one or more workpieces 80 placed (stacked randomly) in the workpiece storage box 90 that is a workpiece storage area WS. As shown in FIG. 2, the workpiece 80 of the embodiment is a wire harness including connectors 81, 82 that are rigid parts and a cable 85 that is a soft part having a flexible linear shape (in other words, an indefinite linear shape).

As shown in FIG. 1, the pickup robot 10 includes a holder 11 that holds the workpiece 80 and an articulated arm 12 connected to the holder 11. The pickup robot 10 holds, with the holder 11, the rigid part (connector 81 or connector 82) of the workpiece 80 in the workpiece storage area WS (inside the workpiece storage box 90), and takes out the workpiece 80 from the workpiece storage area WS (workpiece storage box 90). In the embodiment, the articulated arm 12 is constituted by an articulated robot (YASKAWA GP-7) manufactured by Yaskawa Electric Corporation.

The 3D vision sensor 20 is a known 3D vision sensor, and is attached to a ceiling of the frame 70. The 3D vision sensor 20 generates three-dimensional measurement data (three-dimensional image data) of the workpiece 80 located inside the workpiece storage box 90 that is the workpiece storage area WS. In the embodiment, the 3D vision sensor 20 is constituted by Machine Vision (RV500) manufactured by Canon.

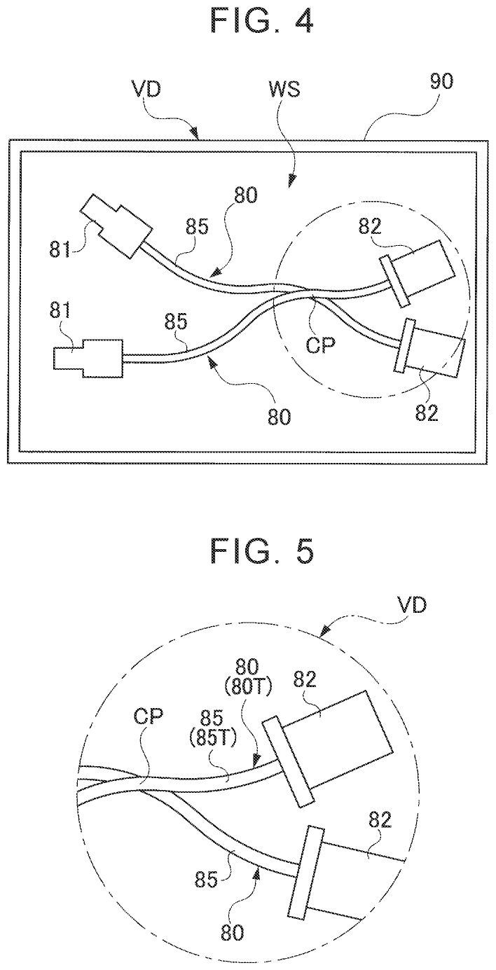

The 2D vision sensor 30 is a known 2D vision sensor, and is attached to an end of the pickup robot 10. The 2D vision sensor 30 takes an image of the inside of the workpiece storage box 90 that is the workpiece storage area WS to generate a two-dimensional image VD (two-dimensional image data, see FIG. 4) of the inside of the workpiece storage box 90.

The image analysis unit 40 is a computer that constitute an artificial intelligence (AI) or the like, and acquires the two-dimensional image VD (two-dimensional image data) of the workpiece 80, which is generated by the 2D vision sensor 30, and analyzes the generated image. Specifically, the image analysis unit 40 acquires, for example, the two-dimensional image VD (two-dimensional image data) generated by the 2D vision sensor 30, and, based on the acquired two-dimensional image VD (see FIG. 4), determines whether there is the workpiece 80 inside the workpiece storage box 90 that is the workpiece storage area WS.

When determining that there is the workpiece 80, the image analysis unit 40 determines whether there is an overlap CP (see FIGS. 4 and 5) where the cables 85 (soft parts) of the workpieces 80 overlap each other in the workpiece storage area WS (inside the workpiece storage box 90), based on the acquired two-dimensional image VD. When determining that there is the overlap CP, the image analysis unit 40 identifies, based on the acquired two-dimensional image VD, an uppermost cable 85T (uppermost soft part) located at the highest position (closest to the viewer of the sheet of FIGS. 4 and 5), out of the overlapping cables 85 (soft parts) (see FIG. 5).

In the image analysis unit 40, data prepared by combining image data of multiple arrangement patterns in which the workpieces 80 are arranged at various positions in the workpiece storage area WS (inside the workpiece storage box 90) and data of the uppermost cable 85T (uppermost soft part) in each arrangement pattern are stored (provided) in advance. Based on the acquired two-dimensional image VD (see FIGS. 4 and 5), the image analysis unit 40 can identify the uppermost cable 85T (uppermost soft part) among the overlapping cables 85 (soft parts).

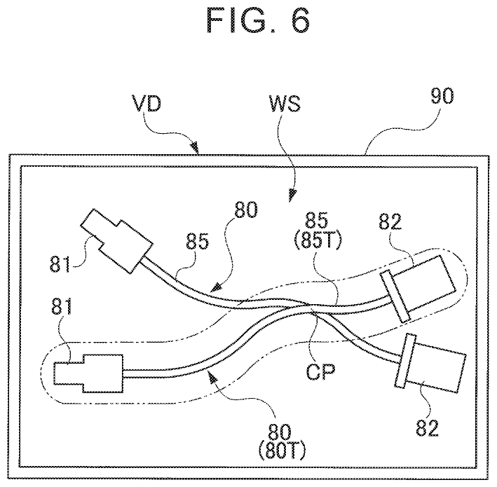

Further, based on the acquired two-dimensional image VD, the image analysis unit 40 determines whether the cable 85 that is the soft part and the connectors 81, 82 that are the rigid parts can be recognized for the workpiece 80 having the identified uppermost cable 85T (in the example illustrated in FIG. 6, the workpiece 80 having the connector 82 that is the rigid part, which is located at a higher position in FIG. 6, out of the two workpieces 80 shown in FIG. 6). Specifically, for example, when the entire cable 85 (soft part) and the entire connectors 81, 82 (rigid parts) appear in the acquired two-dimensional image VD, and the entire cable 85 (soft part) and the entire connectors 81, 82 (rigid parts) can be observed in the acquired two-dimensional image VD, the image analysis unit 40 determines that the cable 85 (uppermost cable 85T) that is the soft part and the connectors 81, 82 that are the rigid parts can be recognized for the workpiece 80 having the identified uppermost cable 85T (see FIG. 6).

Thus, by recognizing the cable 85 (soft part) and the connectors 81, 82 (rigid parts) of the workpiece 80 having the identified uppermost cable 85T (uppermost soft part), it is possible to determine the workpiece 80 as the wire harness constituted by the connectors 81, 82 that are the rigid parts and the cable 85 that is the soft part (in other words, a wire harness in which the connectors 81, 82 that are the rigid parts and the cable 85 that is the soft part are integrated).

Further, when determining that the cable 85 (uppermost cable 85T) that is the soft part and the connectors 81, 82 that are the rigid parts can be recognized, the image analysis unit 40 determines the workpiece 80 having the uppermost cable 85T as an uppermost workpiece 80T. In this embodiment, VisionPro ViDi manufactured by COGNEX is used as software for the image analysis unit 40.

The 3D vision controller 60 is a device that acquires and processes three-dimensional measurement data (three-dimensional image data) generated by the 3D vision sensor 20. The 3D vision controller 60 stores in advance three-dimensional CAD data of the connectors 81, 82 (rigid parts) of the workpiece 80. The 3D vision controller 60 acquires, for example, three-dimensional measurement data (three-dimensional image data) of the workpiece 80 in the workpiece storage area WS (inside the workpiece storage box 90), which is generated by the 3D vision sensor 20. The 3D vision controller 60 matches the three-dimensional measurement data of the rigid part (connector 81 or connector 82), which is selected from the acquired three-dimensional measurement data (three-dimensional image data), with the three-dimensional CAD data of the rigid part (connector 81 or connector 82), thereby recognizing (detecting) the three-dimensional position and posture of the rigid part (connector 81 or connector 82) of the workpiece 80.

The robot controller 50 is a device that controls motion of the pickup robot 10. The robot controller 50 controls the motion of the pickup robot 10 based on processing results from the image analysis unit 40 or processing results from the 3D vision controller 60. Specifically, for example, the robot controller 50 controls the motion of the articulated arm 12 and the holder 11 of the pickup robot 10 based on the three-dimensional position and posture of the rigid part (connector 81 or connector 82) of the workpiece 80 recognized (detected) by the 3D vision controller 60. Thereby the robot controller 50 performs control to cause the holder 11 to hold the rigid part (connector 81 or connector 82) of the workpiece 80 and take out the workpiece 80 from the workpiece storage area WS (workpiece storage box 90).

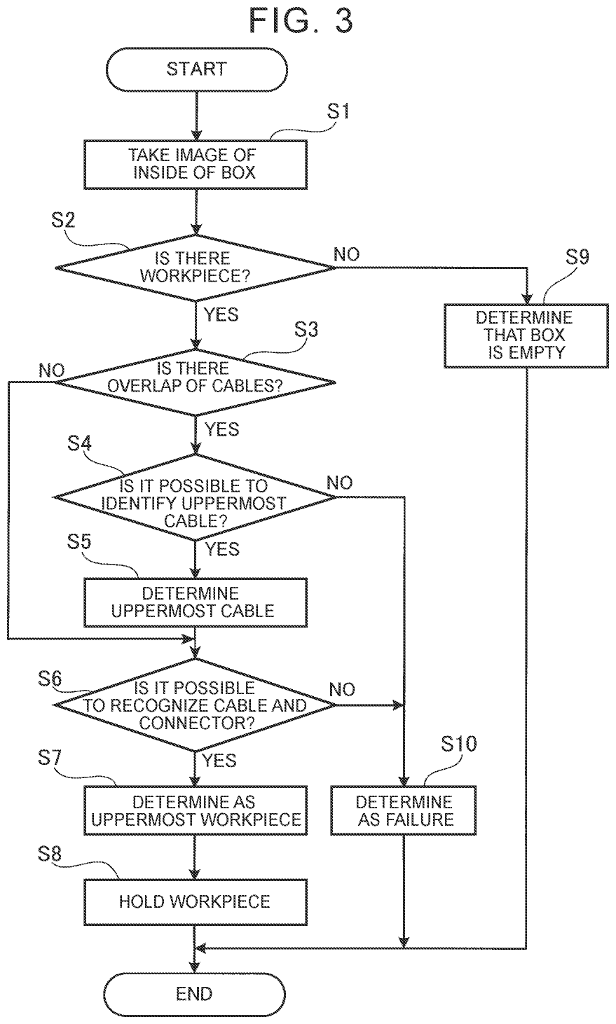

Next, a method for identifying a workpiece according to the embodiment will be described. FIG. 3 is a flowchart illustrating a flow of the method for identifying a workpiece according to the embodiment. First, in step S1 (image-taking step), the 2D vision sensor 30 takes an image of the inside of the workpiece storage box 90 that is the workpiece storage area WS to generate the two-dimensional image VD (two-dimensional image data, see FIG. 4) of the inside of the workpiece storage box 90. Then, in step S2 (workpiece presence/absence determination step), the image analysis unit 40 acquires the two-dimensional image VD (two-dimensional image data) generated by the 2D vision sensor 30, and based on the acquired two-dimensional image VD (see FIG. 4), determines whether there is the workpiece 80 inside the workpiece storage box 90 that is the workpiece storage area WS.

When it is determined in step S2 that there is no workpiece 80 in the workpiece storage area WS (inside the workpiece storage box 90) (NO), the process proceeds to step S9. In step S9, the image analysis unit 40 determines that the workpiece storage box 90 is empty, and a series of workpiece identification processes ends. On the other hand, when it is determined that there is the workpiece 80 in the workpiece storage area WS (inside the workpiece storage box 90), the process proceeds to step S3 (overlap presence/absence determination step). In step S3, the image analysis unit 40 determines whether there is the overlap CP (see FIGS. 4 and 5) where the cables 85 (soft parts) of the workpieces 80 overlap each other in the workpiece storage area WS (inside the workpiece storage box 90), based on the acquired two-dimensional image VD.

When it is determined in step S3 that there is no overlap CP (NO), the process proceeds to step S6 described below. On the other hand, when it is determined in step S3 that there is the overlap CP (YES), the process proceeds to step S4 (uppermost soft part identification step). In step S4, the image analysis unit 40 determines whether it is possible to identify, based on the acquired two-dimensional image VD (see FIGS. 4 and 5), the uppermost cable 85T (uppermost soft part) located at the highest position (closest to the viewer of the sheet of FIGS. 4 and 5) among the overlapping cables 85 (soft parts).

When the image analysis unit 40 determines in step S4 that the uppermost cable 85T (uppermost soft part) cannot be identified (NO), the process proceeds to step S10, where it is determined that there is an identification failure. Then, the series of workpiece identification processes ends. On the other hand, when it is determined in step S4 that the uppermost cable 85T (uppermost soft part) can be identified (YES), then in step S5 (uppermost soft part identification step), the cable 85 that is identified as the cable positioned at the highest position, among the overlapping cables 85 (soft parts), is determined as the uppermost cable 85T (uppermost soft part) (see FIGS. 4 and 5).

Next, in step S6 (workpiece recognition possibility determination step), the image analysis unit 40 determines, based on the acquired two-dimensional image VD, whether the cable 85 that is the soft part and the connectors 81, 82 that are the rigid parts can be recognized for the workpiece 80 having the identified uppermost cable 85T. In the example shown in FIGS. 4 to 6, out of the two workpieces 80 shown in FIGS. 4 to 6, the workpiece 80 having the connector 82 that is the rigid part, which is located at the higher position in the drawings, is the workpiece 80 having the uppermost cable 85T.

Specifically, for example, when the entire cable 85 (soft part) and the entire connectors 81, 82 (rigid parts) of the workpiece 80 having the uppermost cable 85T (workpiece 80 enclosed by a long dashed double-short dashed line in FIG. 6) appear in the acquired two-dimensional image VD as shown in FIG. 6, and the entire cable 85 (soft part) and the entire connectors 81, 82 (rigid parts) can be observed in the acquired two-dimensional image VD, the image analysis unit 40 determines that the cable 85 (uppermost cable 85T) that is the soft part and the connectors 81, 82 that are the rigid parts can be recognized for the workpiece 80 having the uppermost cable 85T.

When it is determined in step S6 that either the cable 85 or the connectors 81, 82 of the workpiece 80 having the uppermost cable 85T cannot be recognized (NO), the process proceeds to step S10, where it is determined that there is an identification failure. Then, the series of workpiece identification processes ends. On the other hand, when it is determined in step S6 that the cable 85 and the connectors 81, 82 of the workpiece 80 having the uppermost cable 85T can be recognized (YES), then in step S7 (uppermost workpiece determination step), the image analysis unit 40 determines the workpiece 80 having the uppermost cable 85T as the uppermost workpiece 80T.

As described above, by the method for identifying a workpiece according to the embodiment, in the case where there are workpieces 80 (stacked randomly) in the workpiece storage area WS (inside the workpiece storage box 90) with their soft parts (cables 85) overlapping one another, it is possible to identify the uppermost workpiece 80T that is located at the highest position among the workpieces 80.

Then, the process proceeds to step S8, where the pickup robot 10 holds the rigid part (connector 81 or connector 82) of the uppermost workpiece 80T with the holder 11, and takes the uppermost workpiece 80T out of the workpiece storage area WS (workpiece storage box 90).

Specifically, the 3D vision sensor 20 first generates the three-dimensional measurement data (three-dimensional image data) of the uppermost workpiece 80T located in the workpiece storage area WS (inside the workpiece storage box 90). Thereafter, the 3D vision controller 60 acquires the three-dimensional measurement data of the uppermost workpiece 80T, which is generated by the 3D vision sensor 20. Further, the 3D vision controller 60 detects the rigid part (connector 81 or connector 82) of the uppermost workpiece 80T from the acquired three-dimensional measurement data, and matches the three-dimensional measurement data of the detected rigid part (connector 81 or connector 82) with the three-dimensional CAD data of the rigid part (connector 81 or connector 82), so as to recognize (detect) the three-dimensional position and posture of the rigid part (connector 81 or connector 82) of the uppermost workpiece 80T.

The robot controller 50 then controls the motion of the articulated arm 12 and the holder 11 of the pickup robot 10 based on the three-dimensional position and posture of the rigid part (connector 81 or connector 82) of the uppermost workpiece 80T, which are recognized (detected) by the 3D vision controller 60, and causes the holder 11 to hold the rigid part (connector 81 or connector 82) of the uppermost workpiece 80T. For example, the robot controller 50 controls the motion of the articulated arm 12 and the holder 11 of the pickup robot 10 based on the three-dimensional position and posture of the connector 82 (rigid part) of the uppermost workpiece 80T, which are recognized (detected) by the 3D vision controller 60, and causes the holder 11 to hold the connector 82 (rigid part) of the uppermost workpiece 80T.

Thereafter, the uppermost workpiece 80T held by the holder 11 is taken out of the workpiece storage area WS (workpiece storage box 90) by the pickup robot 10 under the control of the robot controller 50.

### Uppermost Workpiece Identification Test

Next, an uppermost workpiece identification test will be described. In this test, it is determined whether the uppermost workpiece 80T (workpiece 80 that is located at the highest position in the workpiece storage area WS) can be identified by the pickup device 1 of the embodiment for the cases where the number of the workpieces 80 stacked randomly in the workpiece storage area WS (inside the workpiece storage box 90) is two, three, and four.

Specifically, for example, in the case where two workpieces 80 were randomly arranged (stacked randomly) in the workpiece storage area WS, whether the pickup device 1 of the embodiment can identify and pick up the uppermost workpiece 80T was tested a plurality of times (for example, 100 times), so as to study a success rate of identification of the uppermost workpiece 80T (referred to as an uppermost workpiece identification rate). The determination as to whether the identification of the uppermost workpiece 80T was successful was made based on whether the uppermost workpiece 80T was picked up by the pickup device 1. The same test was performed for each of the cases where the number of the workpieces 80 stacked randomly in the workpiece storage area WS was three and four. The results of the tests are shown in Table 1 as the uppermost workpiece identification rate (%).

In order to identify the uppermost cable 85T (uppermost soft part) among the overlapping cables 85 (soft parts) in the workpiece storage area WS, the number of images provided in advance to the image analysis unit 40 (referred to as the number of training images, see Table 1) is: 10 when the number of workpieces 80 stacked randomly in the workpiece storage area WS is two; 30 when the number of workpieces 80 stacked randomly in the workpiece storage area WS is three; and 50 when the number of workpieces 80 stacked randomly in the workpiece storage area WS is four. More specifically, when the number of workpieces 80 stacked randomly in the workpiece storage area WS is two, data prepared by combining image data of ten different arrangement (random stacking) patterns of the workpieces 80 (10 images) and data of the uppermost cable 85T (uppermost soft part) in each arrangement pattern was provided in advance to the image analysis unit 40.

When the number of workpieces 80 stacked randomly in the workpiece storage area WS is three, data prepared by combining image data of 30 different arrangement (random stacking) patterns of the workpieces 80 (30 images) and data of the uppermost cable 85T (uppermost soft part) in each arrangement pattern was provided in advance to the image analysis unit 40. When the number of the workpieces 80 stacked randomly in the workpiece storage area WS is four, data prepared by combining image data of 50 different arrangement (random stacking) patterns of the workpieces 80 (50 images) and data of the uppermost cable 85T (uppermost soft part) in each arrangement pattern was provided in advance to the image analysis unit 40.

As shown in Table 1, when the number of workpieces 80 stacked randomly in the workpiece storage area WS was two, the uppermost workpiece identification rate was 100%. That is, in all of the plurality of (for example, 100) tests, the uppermost workpiece 80T (the uppermost cable 85T) could be identified and picked up without erroneous identification. When the number of workpieces 80 stacked randomly in the workpiece storage area WS was three, the uppermost workpiece identification rate was 97%. Even when the number of workpieces 80 stacked randomly in the workpiece storage area WS was four, the uppermost workpiece identification rate was 85%, achieving a high identification rate.

TABLE 1

| Number of | Number of Training | Uppermost Workpiece |
|---|---|---|
| Workpieces | Images | Identification Rate |
| 2 | 10 | 100% |
| 3 | 30 | 97% |
| 4 | 50 | 85% |

The disclosure has been described above with reference to the embodiment. However, it is needless to say that the disclosure is not limited to the above-described embodiment, and can be appropriately modified for application without departing from the scope of the disclosure.

For example, in the embodiment, the wire harness has been discussed as the workpiece 80 to be identified, which is constituted by connectors 81, 82 that are the rigid parts and a cable 85 that is the soft part with a flexible linear shape. However, the workpiece to be identified in the disclosure is not limited to the wire harness, and may be any workpiece as long as it is constituted by a rigid part and a soft part with a flexible linear shape.

What is claimed is:

1. A method for identifying a workpiece, the method comprising:
taking an image of a workpiece storage area in which a plurality of workpieces is placed, each of the workpieces including a rigid part and a soft part having a flexible linear shape;
determining whether there is the workpiece in the workpiece storage area based on the image taken;
determining, when it is determined that there is the workpiece in the workpiece storage area, whether there is an overlap where the soft parts of the workpieces overlap one another in the workpiece storage area, based on the image;
identifying, when it is determined that there is the overlap, an uppermost soft part that is located at a highest position among the overlapping soft parts, based on the image; and
determining the workpiece having the identified uppermost soft part as an uppermost workpiece that is located at a highest position among the workpieces in the workpiece storage area.

2. The method according to claim 1, wherein
determining, after the uppermost soft part is identified and before the uppermost workpiece is determined, whether the soft part and the rigid part are recognizable for the workpiece having the identified uppermost soft part, based on the image, and
determining, when it is determined that the soft part and the rigid part are recognizable, the workpiece having the uppermost soft part as the uppermost workpiece.
